(19) United States
(12) Patent Application Publication
(10) Pub. No.: US 2010/0111637 A1
(43) Pub. Date: May 6, 2010

(54) FASTENING ASSEMBLY

(75) Inventors: Jin-Xin Wang, Shenzhen City (CN); Chao-Zhong Fu, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTDD., Shenzhen City (CN); HON HAI PRECISION INDUSTRY CO., LTD., Tu-Cheng (TW)

(21) Appl. No.: 12/344,677

(22) Filed: Dec. 29, 2008

(30) Foreign Application Priority Data
Oct. 31, 2008 (CN) 200810305324.0

(51) Int. Cl. F16B 37/04; B29C 45/00

(52) U.S. Cl. 411/111; 264/242

(57) ABSTRACT

A fastening assembly includes a threaded fastening member, a slidable member, and a resilient member. The threaded fastening member has a threaded portion. The slidable member is slidably sleeved on the threaded fastening member. The slidable member forms a resisting portion defining a threaded hole. The threaded hole is engagable with the threaded portion. The resilient member resists the threaded fastening member and the slidable member. The threaded portion of the threaded fastening member extends through the threaded hole.

### BACKGROUND

1. Field of the Invention

The present disclosure generally relates to fastening assemblies and, particularly, to a counter-rotate fastening assembly.

2. Description of the Related Art

When assembling two or more components together, fastening members such as bolts are usually used to connect the components. However, the fastening members may loosen when the fastening members during vibration and repeated cyclic loading. Thus, the fastening members may loosen or fall off from the components over time. A counter-rotate mechanism may be formed on the fastening members to prevent the fastening members from loosening or falling off.

A typical fastening assembly includes a housing, a tube partially received in the housing, a threaded pole extending through the housing and the tube, and a spring received in the housing. A top end of the tube forms a flange and a bottom end of the housing forms a flange engaging with the flange of the tube, thus preventing the tube from falling off from the housing. Ends of the spring resist the tube and the threaded pole. When the fastening assembly is used to connect components, the spring is compressed and generates an elastic force to resist the tube. The tube tightly contacts a surface of the components, thus preventing the fastening assembly from rotating relative to the components.

However, the tube is not detachable from the housing. The housing should be machined to form a flange at an end to prevent the tube from falling off during assembling the tube to the housing, making assembly inconvenient. In addition, if one of the tube and the housing is damaged, both the tube and the housing must be replaced, increasing costs.

Therefore, a new fastening assembly is desired to overcome the above-described shortcomings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an assembled, isometric view of one embodiment of a fastening assembly.

FIG. 2 is an exploded, isometric view of the fastening assembly of FIG. 1.

FIG. 3 is a cut-away view of the fastening assembly of FIG. 1.

FIG. 4 is a cross-sectional view of the fastening assembly of FIG. 1, showing the fastening assembly connecting two components.

### DETAILED DESCRIPTION OF THE EMBODIMENTS

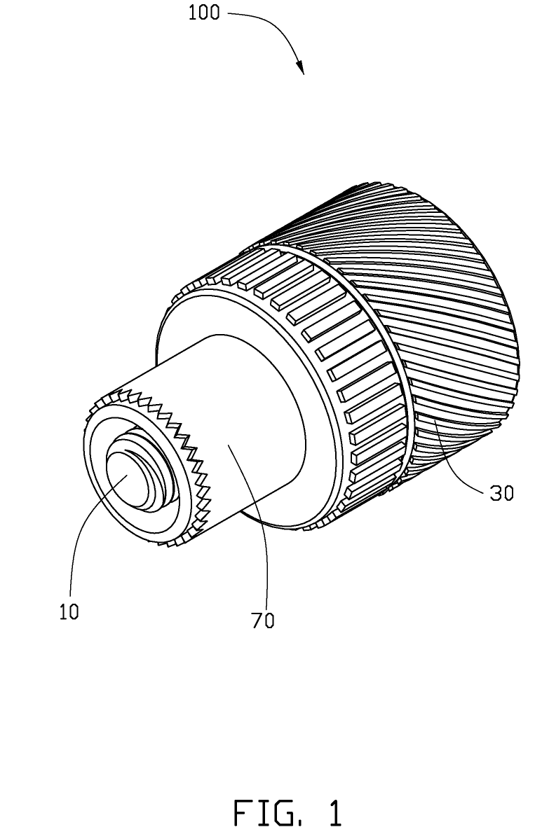

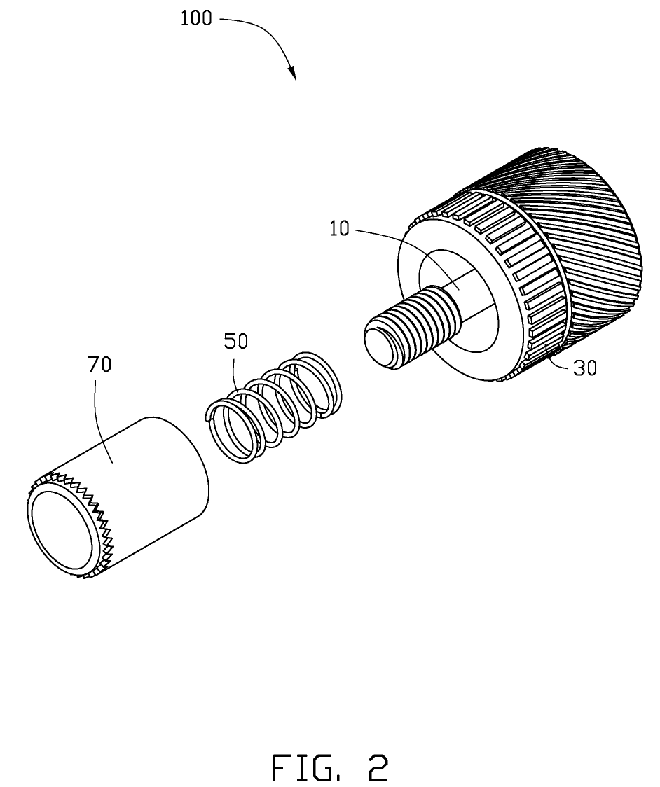

Referring to FIG. 1 and FIG. 2, one embodiment of a fastening assembly 100 includes a threaded fastening member 10, a housing 30 sleeved on the threaded fastening member 10, a resilient member 50, and a slidable member 70.

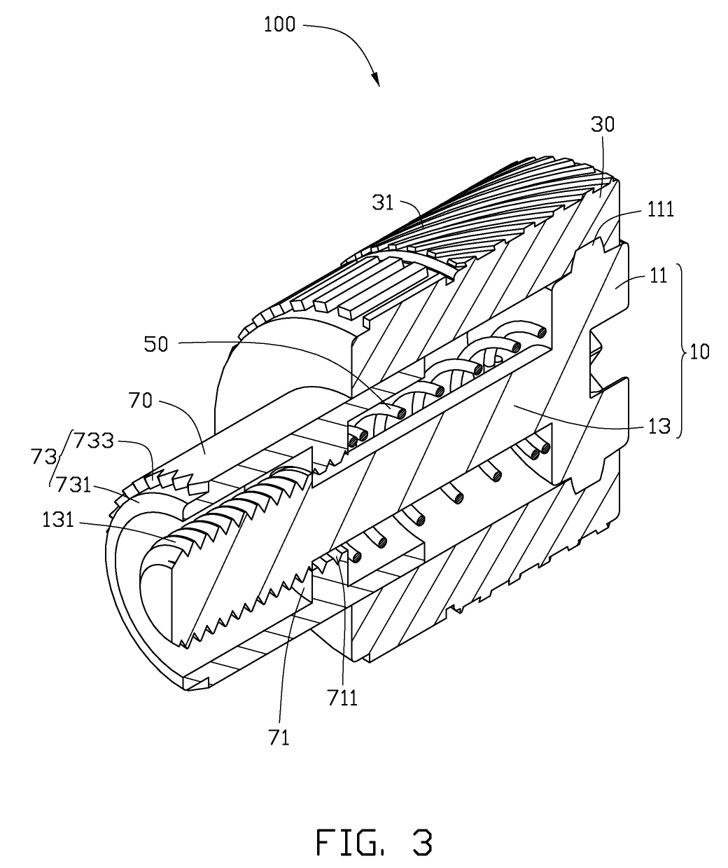

Also referring to FIG. 3, the threaded fastening member 10 is a bolt including a cap 11 and a shaft portion 13. The cap 11 forms a flange 111 adjacent to an end opposite to the shaft portion 13. The shaft portion 13 forms a threaded portion 131 at an end opposite to the cap 11.

The housing 30 may be a hollow cylinder. The housing 30 defines a friction portion 31 at an outer surface. In the illustrated embodiment, the friction portion 31 includes a plurality of elongated protrusions. The housing 30 is fixed relative to the threaded fastening member 10. In the illustrated embodiment, the housing 30 and the threaded fastening member 10 are integrally formed by injection molding. The flange 111 is engaged in the housing 30. In alternative embodiments, the threaded fastening member 10 and the housing 30 may be fixed together by other manners, such as welding, riveting, and so on. The cap 11 of the threaded fastening member 10 may be exposed out of one end of the housing 30, and the threaded portion 131 of the threaded fastening member 10 protrudes out of the other end of the housing 30.

In the illustrated embodiment, the resilient member 50 is a column, compression spring, received in the housing 30 and sleeved on the shaft portion 13.

The slidable member 70 is a hollow cylinder forming a resisting portion 71 at a middle portion of an inner surface of the slidable member 70 and a joining portion 73 at one end. The resisting portion 71 defines a threaded hole 711 capable of engaging with the threaded portion 131 of the threaded fastening member 10. The joining portion 73 includes a flat end 731 and a plurality of teeth 733.

The resilient member 50 is sleeved on the shaft portion 13 of the threaded fastening member 10. The shaft portion 13 of the threaded fastening member 10 extends through the threaded hole 711 of the slidable member 70 by rotating the threaded fastening member 10. When the threaded portion 131 of the shaft portion 131 passes the threaded hole 711, the slidable member 70 is partially received in the housing 30. Ends of the resilient member 50 resist the cap 11 of the threaded fastening member 10 and the resisting portion 71 of the slidable member 70.

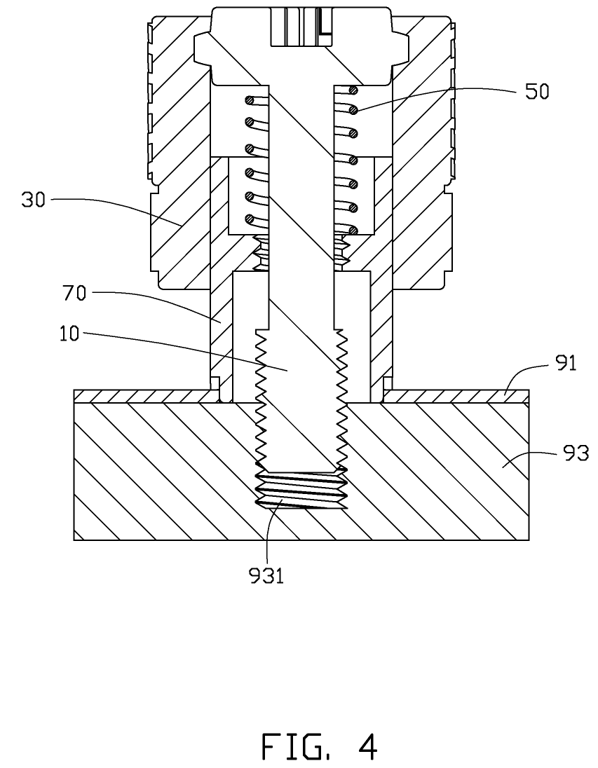

FIG. 4 shows the fastening assembly 100 used to connect a first component 91 to a second component 93. The first component 91 defines a first connecting hole (not labeled), and the second component 93 defines a threaded second connecting hole 931. A diameter of the first connecting hole corresponds to an outer diameter of the flat end 731 of the slidable member 70. The threaded portion 131 of the threaded fastening member 10 runs through the first connecting hole and engages with the second connecting hole 931. As the threaded portion 131 engages in the second connecting hole 931, the slidable member 70 slides relative to the housing 30, the resilient member 50 is compressed, and the teeth 733 abut against the first component 91. An elastic force generated by the resilient member 50 acts on the slidable member 70, and as a result, the slidable member 70 resists a surface of the first component 91. Therefore, the slidable member 70 is prevented from rotating relative to the first component 91, and the fastening assembly 100 avoids or reduces the likelihood of becoming loosened or disengaging from the first and second components 91, 93.

In addition, if one of the slidable member 70 and the threaded fastening member 10 is damaged, only the damaged member and not both, needs to be replaced. Furthermore, the fastening assembly 100 is easy to assemble.

The engagement of the joining portion 73 and the first connecting hole allows the slidable member 70 to tightly engage with the first component 91. In alternative embodiments, the teeth 733 of the joining portion 73 may be omitted and the diameter of the first connecting hole of the first component 91 may be smaller than the diameter of the slidable member 70. In this case, the flat end 731 resists the surface of the first component 91.

In an alternative embodiment, the resisting portion 71 of the slidable member 70 may define a hole with a protrusion formed on an inner sidewall of the hole and extending parallel to an axis of the resisting portion 71. Accordingly, the shaft portion 13 of the threaded fastening member 10 defines a slot corresponding to the protrusion of the slidable member 70. The threaded fastening member 10 can engage with or detach from the slidable member 70 by making the protrusion of the slidable member 70 face the slot of the threaded fastening member 10. When the protrusion of the slidable member 70 is offset with the slot of the threaded fastening member 10, the threaded fastening member 10 is not detachable from the slidable member 70.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A fastening assembly, comprising:
a threaded fastening member having a threaded portion;
a slidable member slidably sleeved on the threaded fastening member, the slidable member forming a resisting portion, a threaded hole being defined in the resisting portion, the threaded hole being engagable with the threaded portion; and
a resilient member resisting the threaded fastening member and the slidable member, wherein the threaded portion of the threaded fastening member extends through the threaded hole.

2. The fastening assembly of claim 1, further comprising a housing fixed to the threaded fastening member.

3. The fastening assembly of claim 2, wherein the slidable member and the threaded fastening member are partially received in the housing; an outer sidewall of the slidable member slidably engages with an inner sidewall of the housing.

4. The fastening assembly of claim 2, wherein the housing is a hollow cylinder defining a friction portion at an outer surface.

5. The fastening assembly of claim 2, wherein the housing and the threaded fastening member are integrally formed by injection molding.

6. The fastening assembly of claim 1, wherein the threaded fastening member comprises a cap and a shaft portion, the shaft portion forms the threaded portion at an end opposite to the cap.

7. The fastening assembly of claim 6, wherein the resilient member is sleeved on the shaft portion of the threaded fastening member and positioned between the cap of the threaded fastening member and the resisting portion of the slidable member.

8. The fastening assembly of claim 1, wherein the resisting portion is formed at a middle portion of an inner surface of the slidable member; the slidable member further comprises a joining portion at one end, the joining portion comprising a flat end and a plurality of teeth.

9. The fastening assembly of claim 1, wherein the resilient member is a columnar, compression spring.

10. A fastening assembly, comprising:
a threaded fastening member having a threaded portion;
a slidable member slidably sleeved on the threaded fastening member, the slidable member forming a resisting portion, a hole being defined in the resisting portion; and
a resilient member configured to generate an elastic force between the threaded fastening member and the slidable member, wherein the threaded portion of the threaded fastening member can extend through the hole of the slidable member; the slidable member prevents the threaded fastening member from detaching from the slidable member arbitrarily.

11. The fastening assembly of claim 10, further comprising a housing fixed to the threaded fastening member.

12. The fastening assembly of claim 11, wherein the slidable member and the threaded fastening member are partially received in the housing; an outer sidewall of the slidable member slidably engages with an inner sidewall of the housing.

13. The fastening assembly of claim 11, wherein the housing is a hollow cylinder defining a friction portion at an outer surface.

14. The fastening assembly of claim 11, wherein the housing and the threaded fastening member are integrally formed by injection molding.

15. The fastening assembly of claim 10, wherein the threaded fastening member comprises a cap and a shaft portion, the shaft portion forms the threaded portion at an end opposite to the cap.

16. The fastening assembly of claim 15, wherein the resilient member is sleeved on the shaft portion of the threaded fastening member and positioned between the cap of the threaded fastening member and the resisting portion of the slidable member.

17. The fastening assembly of claim 10, wherein the resisting portion is formed at a middle portion of an inner surface of the slidable member; the slidable member further comprises a joining portion at one end, the joining portion comprising a flat end and a plurality of teeth.

18. The fastening assembly of claim 10, wherein the resilient member is a column, compression spring.

19. The fastening assembly of claim 10, wherein the hole of the resisting portion of the threaded fastening member is a threaded hole.
